(19) United States
(12) Patent Application Publication
(10) Pub. No.: US 2025/0048490 A1
(43) Pub. Date: Feb. 6, 2025

(54) UNIFIED EXTENDED DISCONTINUOUS RECEPTION CYCLE AND PAGING TIME WINDOW

(71) Applicant: ZTE Corporation, Shenzhen (CN)

(72) Inventor: Li ZHANG, Shenzhen (CN)

(21) Appl. No.: 18/919,958

(22) Filed: Oct. 18, 2024

Related U.S. Application Data
(63) Continuation of application No. PCT/CN2022/110681, filed on Aug. 5, 2022.

(51) Int. Cl. H04W 76/28; H04W 68/00

(52) U.S. Cl. CPC H04W 76/28; H04W 68/005

(57) ABSTRACT

Methods, apparatus, and systems that relate to unified extended Discontinuous Reception (eDRX) cycles and Paging Time Window (PTW) lengths for the Core Network (CN) and the Radio Access Network (RAN) are disclosed. In one example aspect, a method for wireless communication includes receiving, by a terminal device, configuration information about a first eDRX cycle for a core network and a second eDRX cycle for an access node. The configuration information indicates applicability of a cycle length that is greater than 10.24 seconds upon the terminal device being in a non-active state. The method also includes performing a communication by the terminal device based on the configuration information.

### CROSS-REFERENCE TO RELATED APPLICATIONS

This patent document is a continuation of and claims benefit of priority to International Patent Application No. PCT/CN2022/110681, filed on Aug. 5, 2022. The entire content of the before-mentioned patent application is incorporated by reference as part of the disclosure of this application.

### TECHNICAL FIELD

This patent document is directed to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to a framework for providing unified extended Discontinuous Reception (eDRX) cycles and Paging Time Window (PTW) lengths for the Core Network (CN) and the Radio Access Network (RAN) so as to reduce complexity in paging monitoring.

In one example aspect, a method for wireless communication includes receiving, by a terminal device, configuration information about a first eDRX cycle for a core network and a second eDRX cycle for an access node. The configuration information indicates applicability of a cycle length that is greater than 10.24 seconds upon the terminal device being in a non-active state. The method also includes performing a communication by the terminal device based on the configuration information.

In another example aspect, a method for wireless communication includes transmitting, by an access node to a terminal device, configuration information indicating applicability of a cycle length that is greater than 10.24 seconds upon the terminal device being in a non-active state.

In another example aspect, a method for wireless communication includes transmitting, by an access node to a node in a core network, configuration information indicating applicability of a cycle length that is greater than 10.24 seconds upon a terminal device being in a non-active state.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF THE DRAWINGS

FIG. 1 illustrates an example of a common eDRX cycle of 20.48 see and a common PTW in accordance with one or more embodiments of the present technology.

FIG. 2A illustrates an example of a complete overlap of Paging Hyperframe (PH) between the CN and the RAN.

FIG. 2B illustrates an example of a partial overlap of PH between the CN and the RAN.

FIG. 2C illustrates an example of a non-overlap of PH between the CN and the RAN.

FIG. 3 illustrates an example of partially overlapping PH due to a shorter PTW length of CN.

FIG. 4 is a flowchart representation of a method for wireless communication in accordance with one or more embodiments of the present technology.

FIG. 5A is a flowchart representation of a method for wireless communication in accordance with one or more embodiments of the present technology.

FIG. 5B is a flowchart representation of a method for wireless communication in accordance with one or more embodiments of the present technology.

FIG. 6 shows an example of a wireless communication system where techniques in accordance with one or more embodiments of the present technology can be applied.

FIG. 7 is a block diagram representation of a portion of a radio station in accordance with one or more embodiments of the present technology can be applied.

### DETAILED DESCRIPTION

In wireless communication systems, such as the Long Term Evolution (LTE) wireless communication systems, a User Equipment (UE) can be configured with an extended Discontinuous Reception (eDRX) cycle. When the UE is in an idle state, such as the Radio Resource Control (RRC) IDLE (RRC_IDLE) state, the eDRX cycle has the maximum value of 2621.44 seconds (43.69 minutes). For UEs that support Narrowband (NB) Internet-of-Things (IoT), the maximum value of eDRX cycle is 10485.76 seconds (2.91 hours). Hyper System Frame Number (H-SFN) is broadcasted in System Information and incremented by one when SFN wraps around. The Paging Hyperframe (PH) refers to the H-SFN in which the UE starts to monitor for paging during a Paging Time Window (PTW).

It has been found that a long eDRX cycle can result in significant power saving for UEs. For example, the battery lifetime for a UE with a 2-minute eDRX cycle compared to the same device with 10.24 seconds eDRX cycle is shown to result in 300% to 600% improvements for RRC_IDLE and RRC_INACTIVE, respectively. Therefore, eDRX is beneficial for UE power consumption and can be specified and configured for UEs, particularly UEs having reduced capabilities, so that eDRX cycles can be used in RRC_IDLE and in RRC_INACTIVE states.

However, with different eDRX cycles and/or PTW length, eDRX extension beyond 10.24 seconds for RRC_IDLE and/or RRC_INACTIVE can result in complex paging monitoring scenarios. Several proposals have been considered for PTW and eDRX cycle configuration for RRC_IDLE and RRC_INACTIVE:
1. A common PTW and eDRX cycle.
2. A common PTW but with different eDRX cycle.
3. A common eDRX cycle but with different PTW length.
4. Different eDRX cycles and different PTW lengths.

Details of these proposals and the corresponding techniques to reduce processing complexity and power consumption are further described below.

Proposal 1: A Common PTW and eDRX Cycle.

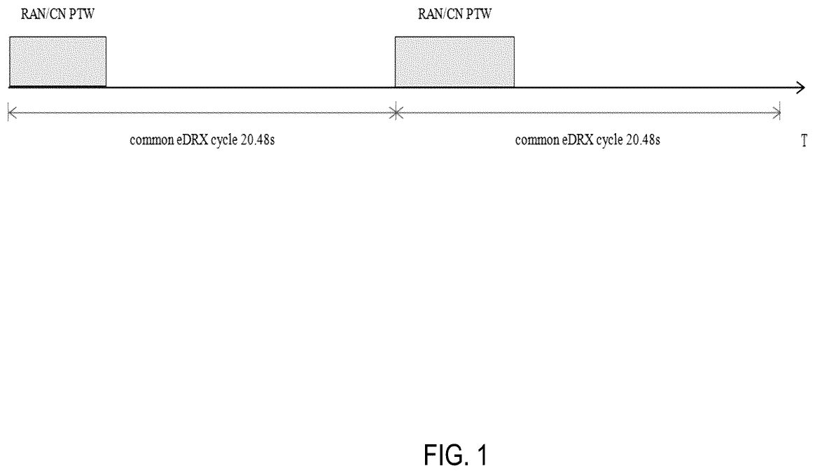

In this proposal, a common eDRX cycle and PTW length can be configured for the RAN and the paging. FIG. 1 illustrates an example of a common eDRX cycle of 20.48 see and a common PTW in accordance with one or more embodiments of the present technology.

In some embodiments, the configuration of the common eDRX cycle can be initiated by the CN. The CN can inform the RAN of the eDRX information in RRC_IDLE state via the Access and Mobility Management Function (AMF). The RAN then indicates the common eDRX cycle using via a RRC signaling or via the system information. In some embodiments, the common eDRX cycle can be predefined or be configured first (e.g., via the system information). Usage of the common eDRX cycle (e.g., enabled or disabled) can be indicated using a signaling message, such as the RRC release message, to reduce signaling overhead. An example of an RRC Information Element (IE) field that indicates usage of the common eDRX is shown in Table 1 below. If present, this IE field indicates that the UE should apply the common eDRX cycle that is greater than 10.24 s. If absent, the UE should disable the common eDRX cycle that is greater than 10.24 s.

TABLE 1
Example IE field in an RRC message

ran-EdrxBeyond10.24-Indication ENUMERATED {enabled} OPTIONAL, -- Need R

In some embodiments, the configuration of the common eDRX cycle can be initiated by the RAN. The RAN can inform the CN of the eDRX information in RRC_INACTIVE state via NAS signaling and/or data that is buffered in CN. In some embodiments, the common eDRX cycle can be predefined. Usage of the common eDRX cycle (e.g., enabled or disabled) can be indicated using a signaling message over the N2 interface, such as the RRC INACTIVE TRANSITION REPORT, or other existing/new N2 message(s), to reduce signaling overhead. Table 2 shows an example of IE field in an N2 message.

TABLE 2
Example IE field in an N2 message

| | | | | |
|---|---|---|---|---|
| | | | IE type and | |
| IE/Group Name | Presence | Range | reference | Semantics description |

| | | | |
|---|---|---|---|
| ran- | O | ENUMERATED | Indicates that eDRX cycle |
| EdrxBeyond10.24 s | | (enabled) | beyond 10.24 s shall be |
| | | | used for |
| | | | RRC_INACTIVE state. |

Proposal 2: A Common PTW Length but with Different eDRX Cycle

Currently, Release 17 of the Third-Generation Partnership Project (3GPP) standard defines a formula for calculating PH given an eDRX cycle value. Table 3 shows an example equation for determining the PH for CN.

TABLE 3
An Example Equation for Determining PH

The PH for CN is the H-SFN satisfying the following equations:
H-SFN mod T_{eDRX}_CN= (UE_ID_H mod T_{eDRX}_CN), where
- UE_ID_H:
- 13 most significant bits of the Hashed ID.
- T_{eDRX}_CN: UE-specific eDRX cycle in Hyper-frames, (T_{eDRX}_CN = 2, ..., 1024 Hyper-
frames) configured by upper layers

Furthermore, a variable PTW_start that denotes the first radio frame of the PH and a variable PTW_end that denotes the last radio frame of the PTW are calculated using the equations shown in Table 4 below.

TABLE 4
Example Equations for Determining PTW_start and PTW_end

PTW_start denotes the first radio frame of the PH that is part of the PTW and has SFN satisfying the
following equation:
SFN = 128 * i_{eDRX}_CN, where
- i_{eDRX}_CN = floor(UE_ID_H /T_{eDRX}_CN) mod 8
PTW_end is the last radio frame of the PTW and has SFN satisfying the following equation:
SFN = (PTW_start + L*100 − 1) mod 1024, where
- L = Paging Time Window (PTW) length (in seconds) configured by upper layers

When different eDRX cycles for RAN and CN are configured, the values of PH can be different, resulting in different paging monitoring behaviors between the RAN and the CN:
Case 1: A complete overlap with the same PTW_start;
Case 2: A partial overlap; or
Case 3: No overlapping

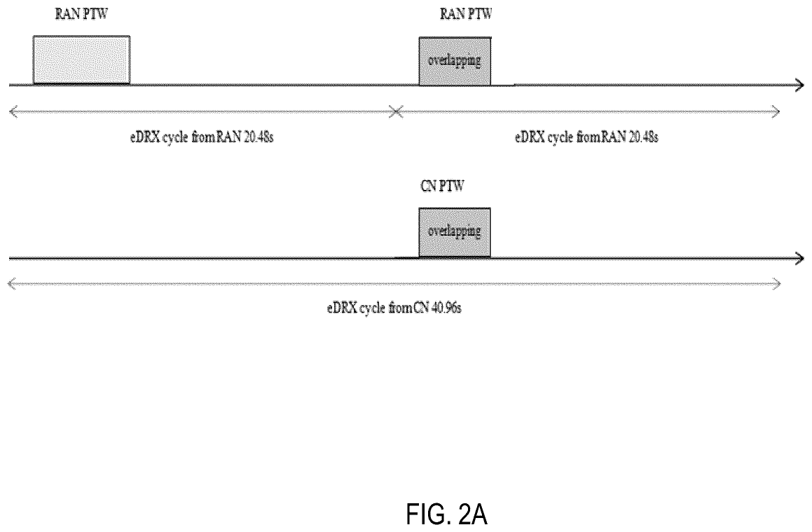

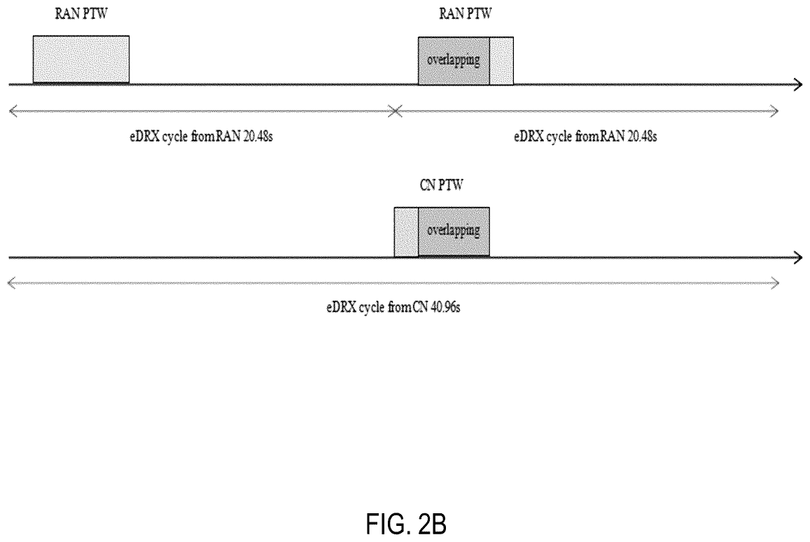

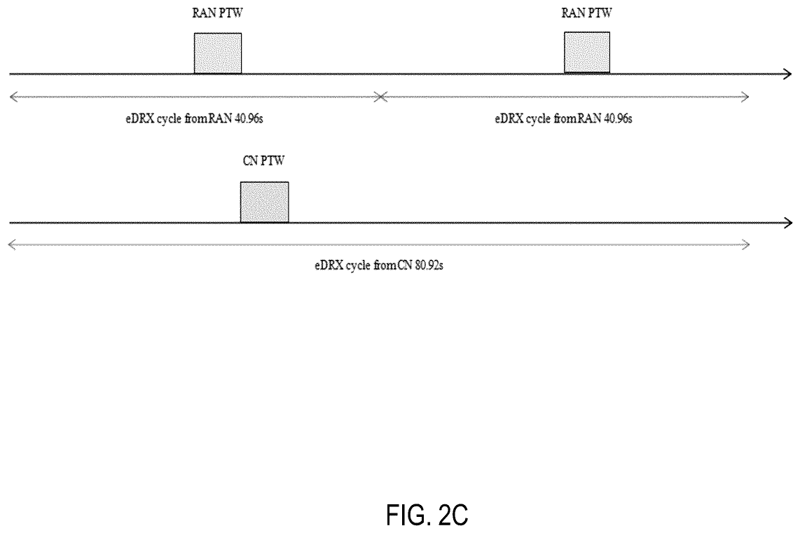

FIG. 2A illustrates an example of a complete overlap of PH between the CN and the RAN. In this example, the RAN is configured with an eDRX cycle of 20.48 sec while the CN is configured with an eDRX cycle of 40.96 sec. A common PTW length is used. The CN and the RAN also have the same PTW_start position, leading to a complete overlap of the PH.

FIG. 2B illustrates an example of a partial overlap of PH between the CN and the RAN. In this example, the RAN is configured with an eDRX cycle of 20.48 sec while the CN is configured with an eDRX cycle of 40.96 sec. While a common PTW length is used, the CN and the RAN have different PTW_start positions, leading to a partial overlap of the PH.

FIG. 2C illustrates an example of a non-overlap of PH between the CN and the RAN. In this example, the RAN is configured with an eDRX cycle of 40.96 sec while the CN is configured with an eDRX cycle of 80.92 sec. While a common PTW length is used, the cycles are long enough that there is no overlap of PH between the CN and the RAN.

The complexity of the cases described above can lead to unnecessary processing complexity for paging monitoring, resulting in higher power usage on the UE side. Therefore, it is desirable to provide a unified eDRX cycle even when different eDRX cycles are configured for the CN and the RAN.

In some embodiments, a predefined rule can specify a unified eDRX cycle based on at least one of the following schemes:
Scheme 1: The unified eDRX cycle can be set to the eDRX cycle configured for CN.
Scheme 2: The unified eDRX cycle can be set to the eDRX cycle configured for RAN.
Scheme 3: The unified eDRX cycle can be the shorter or longer cycle between the first eDRX cycle configured for the CN and the second eDRX cycle configured for the RAN.

In some embodiments, Scheme 1 is adopted, e.g., for the complete overlapping or partial overlapping cases, to determine the PH because the CN can have better insight on the UE traffic profile. The CN is also responsible for eDRX in RRC_IDLE state (UE needs to monitor for CN paging also in RRC_INACTIVE state). Alternatively, or in addition, Schemes 2 and/or 3 can also be applied for the complete overlapping or partial overlapping cases.

In some embodiments, Scheme 2 is adopted, e.g., for the non-overlapping cases, because the RAN can provide more flexibility in the configuration of the eDRX parameters. For example, the RAN can configure different eDRX cycle for the RRC_INACTIVE state.

In some embodiments, Scheme 3 is adopted so that the unified eDRX cycle can be adaptively selected based on the network states/conditions. Table 5 shows an example calculation of PH based on the unified eDRX cycle.

TABLE 5
Example PH Calculation based on the Unified eDRX Cycle

The PH for CN is the H-SFN satisfying the following equations:
T_{eDRX}_unified = (Selection Criteria satisfied) ? T_{eDRX}_CN : T_{eDRX}_RAN
H-SFN mod T_{eDRX}_unified = (UE_ID_H mod T_{eDRX}_unified), where
- UE_ID_H:
- 13 most significant bits of the Hashed ID.
Selection Criteria can be based on network states/conditions.

In some embodiments, given the common PTW length, a unified eDRX cycle can be provided by enforcing that the PTW_start is the same for both the CN and the RAN. Instead of relying on T_{eDRX_CN} and T_{eDRX_RAN} for the calculation of PTW_start, a constant M can be used. Table 6 shows an example calculation of PTW_start that provides a unified eDRX cycle.

TABLE 6
Example Calculation of PTW_start

```
PTW_start denotes the first radio frame of the PH that is part of the PTW and has SFN
satisfying the following equation:
  SFN = 128 * i_{eDRX}_CN, where
    - i_{eDRX}_CN = floor(UE_ID_H /M)
```

In some embodiments, the value of M can be 1024 or 2048. In some embodiments, M is an integer greater than 0. The constant M can be used for PTW_start calculation in the overlapping PH between RAN and CN. It can also be used for the non-overlapping PHs, such as RAN PH or CN PH.

Proposal 3: A Common eDRX Cycle but with Different PTW Lengths.

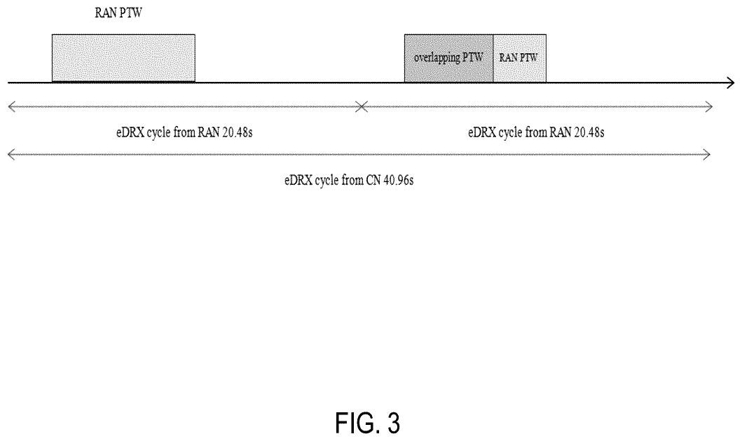

As shown in Table 4, if the CN and the RAN have a common eDRX cycle (that is, T_{eDRX_CN}=T_{eDRX_RAN}), the PTW_start variable for determining the PTW is the same for both CN and RAN. However, different PTW lengths can still lead to different PH scenarios (e.g., completely overlapping, partially overlapping, etc.). FIG. 3 illustrates an example of partially overlapping PH due to a shorter PTW length of CN. The different PH scenarios can increase the processing complexity, resulting in excessive power usage on the UE side. To reduce monitoring complexity and power usage, it is desirable to determine a unified PTW length based on the configured PTW lengths.

In some embodiments, the unified PTW length can be determined based on at least one of the following schemes:
Scheme 1: The unified PTW length can be set to the PTW length configured for CN.
Scheme 2: The unified PTW length can be set to the PTW length configured for RAN.
Scheme 3: The unified PTW length can be the shorter or longer cycle between the first PTW length configured for the CN and the second PTW length configured for the RAN.

The PTW lengths (e.g., in seconds) of the CN and the RAN can be configured by RRC or upper layers. If the PTW length is not configured, the UE can use the PTW length of RRC_IDLE state by default.

Proposal 4: Different eDRX Cycles and Different PTW Lengths.

When both eDRX cycles and the PTW lengths of the CN and the RAN are different, paging monitoring behavior becomes even more complex. As discussed above, to reduce processing complexity and power usage, a unified eDRX cycle and a unified PTW length can be determined based on the configured eDRX cycles and the configured PTW lengths.

In some embodiments, a predefined rule can specify that the eDRX cycle of the CN is equal to or greater than the eDRX cycle of the RAN. In some embodiments, the unified eDRX cycle can be determined based on at least one of the following schemes:
Scheme 1: The unified eDRX cycle can be set to the eDRX cycle configured for CN.
Scheme 2: The unified eDRX cycle can be set to the eDRX cycle configured for RAN.
Scheme 3: The unified eDRX cycle can be the shorter or longer cycle between the first eDRX cycle configured for the CN and the second eDRX cycle configured for the RAN.

In some embodiments, Scheme 1 is adopted, e.g., for the complete overlapping or partial overlapping cases, to determine the PH because the CN can have better insight on the UE traffic profile. The CN is also responsible for eDRX in RRC_IDLE state (UE needs to monitor for CN paging also in RRC_INACTIVE state). Alternatively, or in addition, for the complete overlapping or partial overlapping cases, Schemes 2 and 3 can also be applied.

In some embodiments, Scheme 2 is adopted, e.g., for the non-overlapping cases, because the RAN can provide more flexibility in the configuration of the eDRX parameters. For example, the RAN can configure different eDRX cycle for the RRC_INACTIVE state.

In some embodiments, the unified PTW length can be determined based on at least one of the following schemes:
Scheme 1: The unified PTW length can be set to the PTW length configured for CN.
Scheme 2: The unified PTW length can be set to the PTW length configured for RAN.
Scheme 3: The unified PTW length can be the shorter or longer cycle between the first PTW length configured for the CN and the second PTW length configured for the RAN.

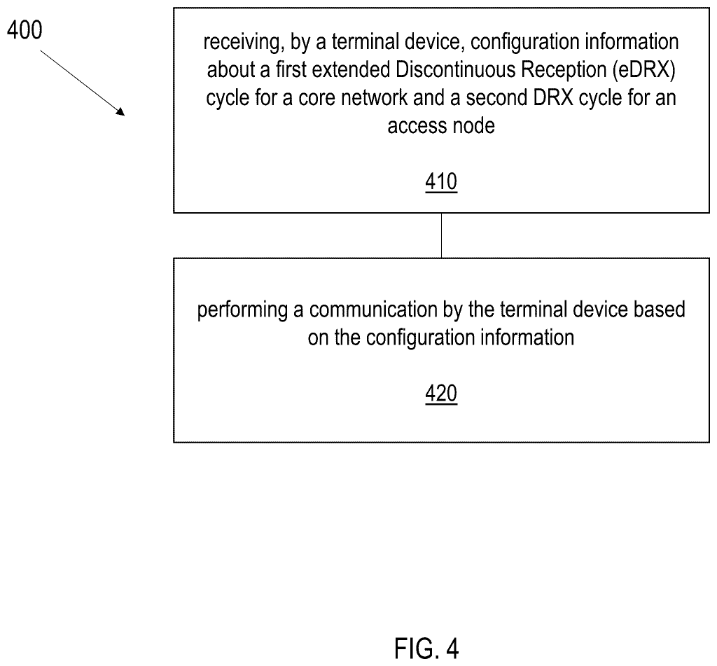

FIG. 4 is a flowchart representation of a method for wireless communication in accordance with one or more embodiments of the present technology. The method 400 includes, at operation 410, receiving, by a terminal device, configuration information about a first extended Discontinuous Reception (eDRX) cycle for a core network and a second DRX cycle for an access node. The configuration information indicates applicability of a cycle length that is greater than 10.24 seconds upon the terminal device being in a non-active state. The method 400 includes, at operation 420, performing a communication by the terminal device based on the configuration information. The non-active state comprises an RRC idle state and an RRC inactive state.

In some embodiments, a common eDRX cycle is used. The first eDRX cycle is equal to the second eDRX cycle. The configuration information comprises a single indicator indicating whether the cycle length greater than 10.24 seconds is enabled. The single indicator can be included in a RRC message or a message on N2 interface.

In some embodiments, a first rule specifies that a unified eDRX cycle with respect to the first eDRX cycle and the second eDRX cycle is used to determine a same starting position of a paging time window for the core network and the access node. The unified eDRX cycle can be equal to the first eDRX cycle for the core network. The unified eDRX cycle can be equal to the second eDRX cycle for the access node. The unified eDRX cycle can be equal to a shorter or a longer cycle of the first eDRX cycle and the second eDRX cycle.

In some embodiments, the configuration information further comprises information about a first paging time window (PTW) length for the core network and a second PTW length for the access node. A second rule specifies that a unified PTW length with respect to the first PTW length and the second PTW length is sued to determine an end position of the paging time window for the core network and the access node. In some embodiments, the unified PTW length is equal to at least one of (1) the first PTW length, (2) the second PTW length, or (3) a shorter or a longer length of the first PTW length and the second PTW length.

In some embodiments, a third rule specifies that a first paging time window (PTW) length for the core network is same as a second PTW length for the access node. A constant cycle value is used to determine a same starting position of the paging time window.

In some embodiments, a fourth rule specifies that the first eDRX cycle is longer than the second eDRX cycle.

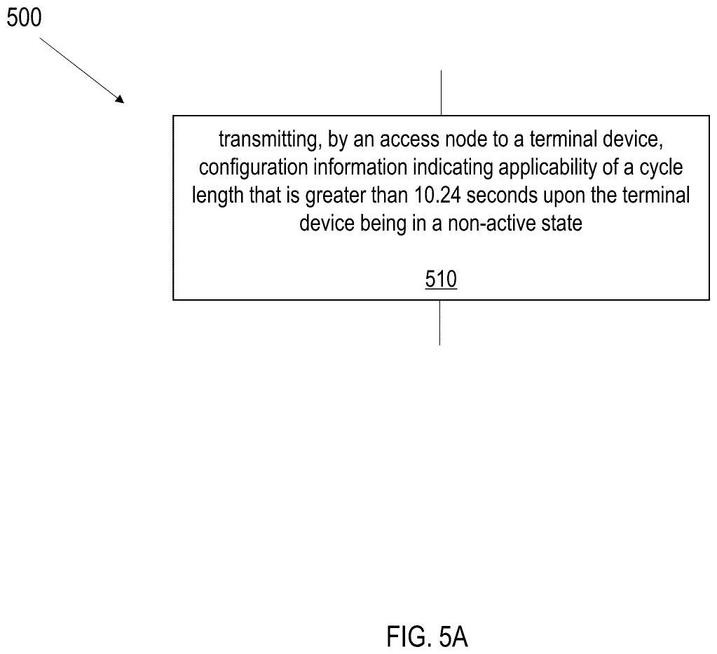

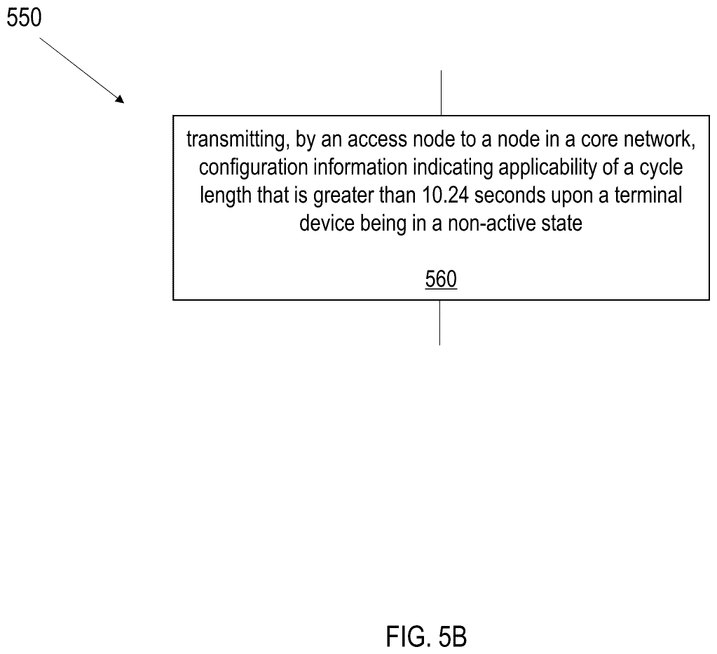

FIG. 5A a flowchart representation of a method for wireless communication in accordance with one or more embodiments of the present technology. The method 500 includes, at operation 510, transmitting, by an access node to a terminal device, configuration information indicating applicability of a cycle length that is greater than 10.24 seconds upon the terminal device being in a non-active state. The configuration information can be included in a RRC message (e.g., from the RAN node to UE).

FIG. 5B a flowchart representation of a method for wireless communication in accordance with one or more embodiments of the present technology. The method 550 includes, at operation 560, transmitting, by an access node to a node in a core network, configuration information indicating applicability of a cycle length that is greater than 10.24 seconds upon a terminal device being in a non-active state. The configuration information is included in a message on N2 interface (e.g., from the RAN node to AMF).

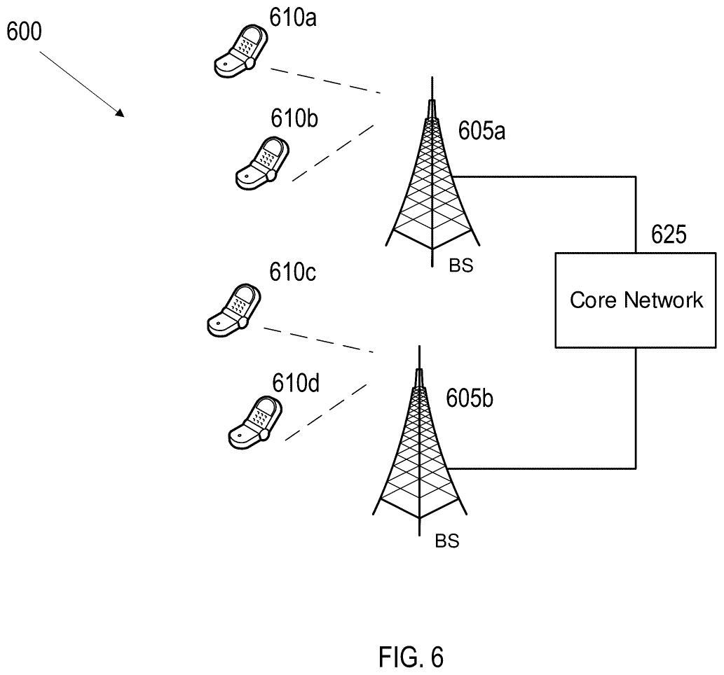

FIG. 6 shows an example of a wireless communication system 600 where techniques in accordance with one or more embodiments of the present technology can be applied. A wireless communication system 600 can include one or more base stations (BSs) 605a, 605b, one or more wireless devices (or UEs) 610a, 610b, 610c, 610d, and a core network 625. A base station 605a, 605b can provide wireless service to user devices 610a, 610b, 610c and 610d in one or more wireless sectors. In some implementations, a base station 605a, 605b includes directional antennas to produce two or more directional beams to provide wireless coverage in different sectors. The core network 625 can communicate with one or more base stations 605a, 605b. The core network 625 provides connectivity with other wireless communication systems and wired communication systems. The core network may include one or more service subscription databases to store information related to the subscribed user devices 610a, 610b, 610c, and 610d. A first base station 605a can provide wireless service based on a first radio access technology, whereas a second base station 605b can provide wireless service based on a second radio access technology. The base stations 605a and 605b may be co-located or may be separately installed in the field according to the deployment scenario. The user devices 610a, 610b, 610c, and 610d can support multiple different radio access technologies. The techniques and embodiments described in the present document may be implemented by the base stations of wireless devices described in the present document.

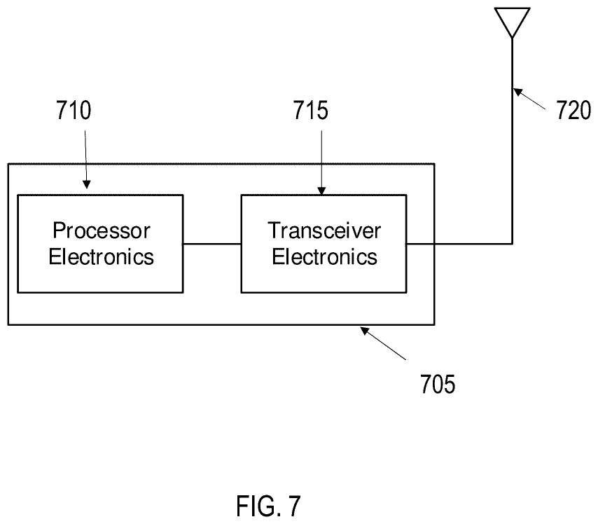

FIG. 7 is a block diagram representation of a portion of a radio station in accordance with one or more embodiments of the present technology can be applied. A radio station 705 such as a network node, a base station, or a wireless device (or a user device, UE) can include processor electronics 710 such as a microprocessor that implements one or more of the wireless techniques presented in this document. The radio station 705 can include transceiver electronics 715 to send and/or receive wireless signals over one or more communication interfaces such as antenna 720. The radio station 705 can include other communication interfaces for transmitting and receiving data. Radio station 705 can include one or more memories (not explicitly shown) configured to store information such as data and/or instructions. In some implementations, the processor electronics 710 can include at least a portion of the transceiver electronics 715. In some embodiments, at least some of the disclosed techniques, modules or functions are implemented using the radio station 705. In some embodiments, the radio station 705 may be configured to perform the methods described herein.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a terminal device, configuration information about a first extended Discontinuous Reception (eDRX) cycle for a core network and a second DRX cycle for an access node, wherein the configuration information includes a single indicator included in a Radio Resource Configuration (RRC) signaling indicating whether a cycle length that is greater than 10.24 seconds upon the terminal device being in a non-active state is enabled; and
performing a communication by the terminal device based on the configuration information.

2. The method of claim 1, wherein a first rule specifies that a unified eDRX cycle with respect to the first eDRX cycle and the second eDRX cycle is used to determine a same starting position of a paging time window for the core network and the access node.

3. The method of claim 2, wherein the unified eDRX cycle is equal to the first eDRX cycle for the core network.

4. The method of claim 2, wherein the configuration information further comprises information about a first paging time window (PTW) length for the core network and a second PTW length for the access node.

5. The method of claim 1, wherein a second rule specifies that the first eDRX cycle is longer than or equal to the second eDRX cycle.

6. A method for wireless communication, comprising:
transmitting, by an access node to a terminal device, configuration information, wherein the configuration information includes a single indicator indicating whether a cycle length that is greater than 10.24 seconds upon the terminal device being in a non-active state is enabled, wherein a first extended Discontinuous Reception (eDRX) cycle for a core network and a second DRX cycle for the access node are configured for the terminal device; and
performing a communication with the terminal device based on the configuration information.

7. The method of claim 6, wherein a first rule specifies that a unified eDRX cycle with respect to the first eDRX cycle and the second eDRX cycle is used to determine a same starting position of a paging time window for the core network and the access node.

8. The method of claim 7, wherein the unified eDRX cycle is equal to the first eDRX cycle for the core network.

9. The method of claim 7, wherein the configuration information further comprises information about a first paging time window (PTW) length for the core network and a second PTW length for the access node.

10. The method of claim 6, wherein a second rule specifies that the first eDRX cycle is longer than or equal to the second eDRX cycle.

11. A device for wireless communication, comprising at least one processor that is configured to cause the device to:
receive configuration information about a first extended Discontinuous Reception (eDRX) cycle for a core network and a second DRX cycle for an access node, wherein the configuration information includes a single indicator included in a Radio Resource Configuration (RRC) signaling indicating whether a cycle length that is greater than 10.24 seconds upon the device being in a non-active state is enabled; and
perform a communication based on the configuration information.

12. The device of claim 11, wherein a first rule specifies that a unified eDRX cycle with respect to the first eDRX cycle and the second eDRX cycle is used to determine a same starting position of a paging time window for the core network and the access node.

13. The device of claim 12, wherein the unified eDRX cycle is equal to the first eDRX cycle for the core network.

14. The device of claim 12, wherein the configuration information further comprises information about a first paging time window (PTW) length for the core network and a second PTW length for the access node.

15. The device of claim 11, wherein a second rule specifies that the first eDRX cycle is longer than or equal to the second eDRX cycle.

16. An apparatus for wireless communication, comprising at least one processor configured to cause the apparatus to:
transmit, to a terminal device, configuration information, wherein the configuration information includes a single indicator indicating whether a cycle length that is greater than 10.24 seconds upon the terminal device being in a non-active state is enabled, wherein a first extended Discontinuous Reception (eDRX) cycle for a core network and a second DRX cycle for apparatus are configured for the terminal device; and
perform a communication with the terminal device based on the configuration information.

17. The apparatus of claim 16, wherein a first rule specifies that a unified eDRX cycle with respect to the first eDRX cycle and the second eDRX cycle is used to determine a same starting position of a paging time window for the core network and the apparatus.

18. The apparatus of claim 17, wherein the unified eDRX cycle is equal to the first eDRX cycle for the core network.

19. The apparatus of claim 17, wherein the configuration information further comprises information about a first paging time window (PTW) length for the core network and a second PTW length for the apparatus.

20. The apparatus of claim 16, wherein a second rule specifies that the first eDRX cycle is longer than or equal to the second eDRX cycle.
